(19) United States
(12) Patent Application Publication
(10) Pub. No.: US 2012/0327663 A1
(43) Pub. Date: Dec. 27, 2012

(54) Light Emitting Diode (LED) Lighting System Having Adjustable Output

(75) Inventor: TRUNG TRI DOAN, Baoshan Hsinchu 308 (TW)

(73) Assignee: SEMILED OPTOELECTRONICS CO., LTD., Miao-Li County (TW)

(21) Appl. No.: 13/165,853

(22) Filed: Jun. 22, 2011

(51) Int. Cl. F21V 29/00; F21V 5/04

(52) U.S. Cl. 362/294; 362/311.02

(57) ABSTRACT

A light emitting diode (LED) lighting system includes a base, a power supply on the base, an LED module on the base having one or more LED dice configured to emit electromagnetic radiation having a selected wavelength range, and multiple interchangeable wavelength conversion lenses configured for removable attachment to the base in light communication with the LED module. Each lens has a different configuration such that the lenses can be changed to vary the electromagnetic radiation output of the light emitting diode (LED) lighting system. The wavelength conversion lenses can be separate from a cover for the light emitting diode (LED) lighting system or can be formed directly on the cover.

### BACKGROUND

This disclosure relates generally to lighting systems and more particularly to light emitting diode (LED) lighting systems.

Light emitting diode (LED) light bulbs have been developed which are interchangeable with conventional light bulbs having incandescent and fluorescent light sources. As such, these light emitting diode (LED) light bulbs can be used in lighting systems for conventional light bulbs. Advantageously, light emitting diode (LED) light bulbs have higher conversion efficiencies, longer lifetimes and lower operating voltages than conventional light bulbs.

However, light emitting diode (LED) light bulbs have different output characteristics than conventional light bulbs. In particular, light emitting diodes (LED) produce electromagnetic radiation in a relatively narrow spectrum band. In order to produce white light, a blue light emitting diode (LED) can be used in combination with a layer of phosphor formed on the bulb or on a separate plate in the bulb. The electromagnetic radiation emitted by the blue light emitting diodes (LED) excites the atoms of the phosphor layer, which converts some of the electromagnetic radiation in the blue wavelength spectrum to the yellow wavelength spectrum. The ratio of the blue to the yellow can be manipulated by the thickness and composition of the phosphor layer, such that the output of the light bulb appears to be white light.

One shortcoming of light emitting diode (LED) light bulbs is that their output is set during manufacture. This provides limited flexibility in constructing a lighting system. The present disclosure is directed to a light emitting diode (LED) lighting system having an adjustable output.

### SUMMARY

A light emitting diode (LED) lighting system includes a base, a power supply on the base, a LED module on the base having one or more LED dice configured to emit electromagnetic radiation having a selected wavelength range, and multiple interchangeable wavelength conversion lenses in light communication with the LED module configured for removable attachment to the base. The lenses can be separate elements, or can be formed on a cover for the light emitting diode (LED) lighting system. Each lens has a particular wavelength conversion material for changing the electromagnetic radiation output of the LED module. Depending on the emission characteristics of the LED module, and the composition of the wavelength conversion material on each lens, the electromagnetic radiation output of the lighting system can be adjusted using different lenses. For example, the LED module can be configured to emit electromagnetic radiation from a blue spectral range, and the wavelength conversion material can be configured to convert some of the electromagnetic radiation into a yellow spectral range. The combination of radiation from the blue spectral range and the yellow spectral range produces an electromagnetic radiation output for the system corresponding to a perceived white light having a particular color temperature.

A second light emitting diode (LED) lighting system includes a wavelength conversion material deposited on a cover, and multiple covers are interchangeable to adjust the electromagnetic radiation output of the system. A third light emitting diode (LED) lighting system includes interchangeable wavelength conversion lenses configured to slip fit on the cover.

### BRIEF DESCRIPTION OF THE DRAWINGS

Exemplary embodiments are illustrated in the referenced figures of the drawings. It is intended that the embodiments and the figures disclosed herein are to be considered illustrative rather than limiting.

FIG. 1A is a schematic cross sectional view of a light emitting diode (LED) lighting system having a cover with multiple interchangeable lenses;

FIG. 1B is a schematic plan view of the interchangeable lenses for the light emitting diode (LED) lighting system of FIG. 1A;

FIG. 2A is a schematic cross sectional view of a second light emitting diode (LED) lighting system in an unassembled condition;

FIG. 2B is a schematic cross sectional view of the second light emitting diode (LED) lighting system in an assembled condition;

FIG. 2C is an enlarged portion of FIG. 2B taken along line 2C;

FIG. 2D is a schematic plan view of interchangeable covers having different lenses for the light emitting diode (LED) lighting system of FIG. 2A;

FIG. 3A is a schematic cross sectional view of a third light emitting diode (LED) lighting system; and

FIG. 3B is a schematic plan view of interchangeable lenses for the light emitting diode (LED) lighting system of FIG. 3A.

### DETAILED DESCRIPTION

It is to be understood that when an element is stated as being “on” another element, it can be directly on the other element or intervening elements can also be present. However, the term “directly” means there are no intervening elements. In addition, although the terms “first”, “second” and “third” are used to describe various elements, these elements should not be limited by the term. Also, unless otherwise defined, all terms are intended to have the same meaning as commonly understood by one of ordinary skill in the art.

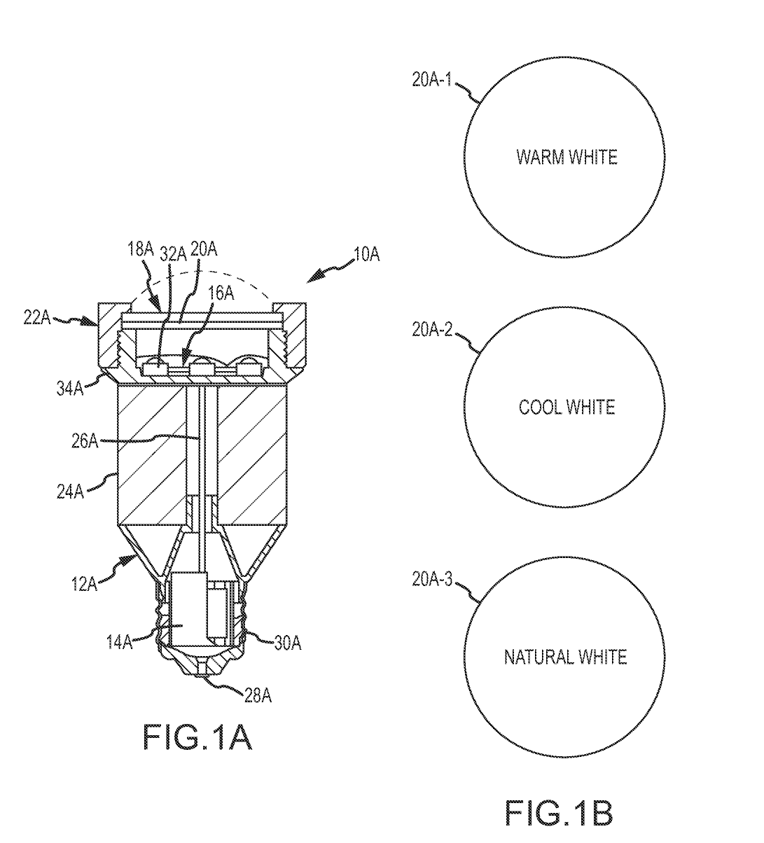

Referring to FIGS. 1A and 1B, a light emitting diode (LED) lighting system 10A includes a base 12A having a power supply 14A, and an LED module 16A mounted to the base 12A in electrical communication with the power supply 14A configured to emit electromagnetic radiation having a selected wavelength range. The light emitting diode (LED) lighting system 10A also includes a cover 18A and a wavelength conversion lens 20A in light communication with the LED module 16A configured for removable attachment to the base 12A. The light emitting diode (LED) lighting system 10A also includes a plurality of interchangeable wavelength conversion lenses 20A-1, 20A-2 and 20A-3 (FIG. 1B) for changing the electromagnetic emission emitted by the LED module 16A to achieve a desired light output for the light emitting diode (LED) lighting system 10A. The light emitting diode (LED) lighting system 10A also includes an attachment mechanism 22A for removeably attaching the cover 18A and the wavelength conversion lenses 20A, 20A-1, 20A-2 or 20A-3 to the base 12A.

As shown in FIG. 1A, the attachment mechanism 22A is in the form of a threaded ring having female threads that mate with the male threads on the base 12A. The attachment mechanism 22A is configured to retain the cover 18A and the wavelength conversion lens 20A but is removable so that the wavelength conversion lens 20A can be removed and replaced with a different wavelength conversion lens 20A-1, 20A-2 or 20A-3 (FIG. 1B). Alternately, rather than having threads, the attachment mechanism 22A can include other attachment features such as screws, snap fits, press fits, compression rings, snap taps, adhesives or various fasteners known in the art. In addition, the light emitting diode (LED) lighting system 10A is in the form of a light bulb having a particular configuration. However, the light emitting diode (LED) lighting system 10A can have any light bulb configuration including but not limited to spotlight, form factor, vivid, miniature, subminiature, Dulux, u-shape, circline, octron, slimline, automotive and special purpose.

As shown in FIG. 1A, the base 12A has a metal screw cap configuration with an electrical contact 28A at the tip and continuous threaded contacts 30A, which also provide mechanical support in a mating socket. Alternately, the base 12A can have other contact arrangements such as bayonet, candelabra, mogul, or screw terminals for connection to wires. The base 12A also includes the power supply 14A for the LED module 16A, which can include an AC-DC converter, a driver circuit and any other electrical components necessary for operating the LED module 16A. The base 12A also includes a heat sink 24A in thermal communication with the LED module 16A and wires 26A which electrically connect the LED module 16A to the contacts 28A, 30A. The base 12A also includes a threaded connector 34A having male threads which mate with female threads on the attachment mechanism 22A. The elements of the base 12A can be combined into are unitary structure using fabrication techniques that are known in the art such as machining, casting and attaching the individual elements.

The LED module 16A can include a single light emitting diode (LED) die 32A, or an array of multiple LED dice 32A, configured to emit electromagnetic radiation having a selected wavelength range. For example, the LED module 16A can be configured to emit electromagnetic radiation from the visible spectral region (e.g., 400-770 nm), the violet-indigo spectral region (e.g., 400-450 nm), the blue spectral region (e.g., 450-490 nm), the green spectral region (e.g., 490-560 nm), the yellow spectral region (e.g., 560-590 nm), the orange spectral region (e.g., 590-635 nm) or the red spectral region (e.g., 635-700 nm).

As shown in FIG. 1A, the cover 18A can be configured to protect the LED module 16A, and can also be configured to collimate or focus the electromagnetic radiation emitted by the LED module 16A. The cover 18A can comprise a transparent, or a semi-transparent material, such as a plastic (e.g., polycarbonate), or a glass, formed in a desired shape. For example, the cover 18A can have a flat circular shape as shown, or a concave shape as indicated by the dotted lines, or any other suitable shape (e.g., tubular, rectangular, dome, convex). As an alternate, the cover 18A can be eliminated and the functions performed by the cover 18A can be incorporated into the wavelength conversion lens 20A. As another alternative the functions of the wavelength conversion lens 20A can be incorporated into the cover 18A.

The wavelength conversion lens 20A can also comprise a transparent, or a semi-transparent material, such as a plastic or a glass, formed in a desired shape, such as the flat circular shape shown. The wavelength conversion lens 20A includes a material configured to convert at least some of the electromagnetic radiation emitted by the LED module 16A into electromagnetic radiation having a different wavelength range. For example, the wavelength conversion lens 20A can include a layer of material, covering one or more major surfaces thereof, configured to convert the electromagnetic radiation emitted by the LED module 16A into electromagnetic radiation having a higher wavelength. For example, if the LED module 16A emits electromagnetic radiation in a blue spectral range, the wavelength conversion lens 20A can include a phosphor layer for converting some of this radiation to a yellow spectral range. A layer of phosphor can be deposited using a suitable process such as spraying, dipping, spin coating, rolling, electro deposition or vapor deposition to a desired thickness. Rather than being a deposited layer, wavelength conversion material, such as phosphor, can also be incorporated into the material of the wavelength conversion lens 20A using a suitable process, such as mixing with a molded plastic material or a rolled glass material.

The electromagnetic radiation emitted by the LED module 16A combined with the electromagnetic radiation converted by the wavelength conversion lens 20A produces an electromagnetic radiation output for the light emitting diode (LED) lighting system 10A. In addition, this electromagnetic radiation output can be selected to achieve a perceived light color for the output of the light emitting diode (LED) lighting system 10A. For example, the LED module 16A and the wavelength conversion lens 20A can be configured such that the light emitting diode (LED) lighting system 10A emits a perceived white light having a selected color temperature. In addition, by interchanging the wavelength conversion lens 20A-1, 20A-2 and 20A-3, a user can vary the color of the light emitted by the light emitting diode (LED) lighting system 10A. For example, white light can have many degrees of white that are described by a Kelvin temperature. Color temperatures over 5,000 K are called cool colors (blueish white), while lower color temperatures (2,700-3,000 K) are called warm colors (yellowish white through red). The interchangeable lenses 20A-1, 20A-2 and 20A-3 permit a user to install a particular lens to produce a desired white light output for the light emitting diode (LED) lighting system 10A. For example, lens 20A-1 can be installed to produce a warm white light. In this case, the lens 20A-1 could include red phosphor mixed with yellow phosphor to make the color warmer. Lens 20A-2 can be installed to produce a cool white light. Lens 20A-3 can be installed to produce a natural white light. Natural white (also known as full spectrum light) simulates the bluish white color and perceived brightness of daylight.

The LED module 16A and the wavelength conversion lens 20A can also be configured such that the light emitting diode (LED) lighting system 10A emits light of a different color, such as red, amber/yellow or green. Advantageously, by attaching different wavelength conversion lenses 20A-1, 20A-2 or 20A-3, different light emissions from the light emitting diode (LED) lighting system 10A can be achieved.

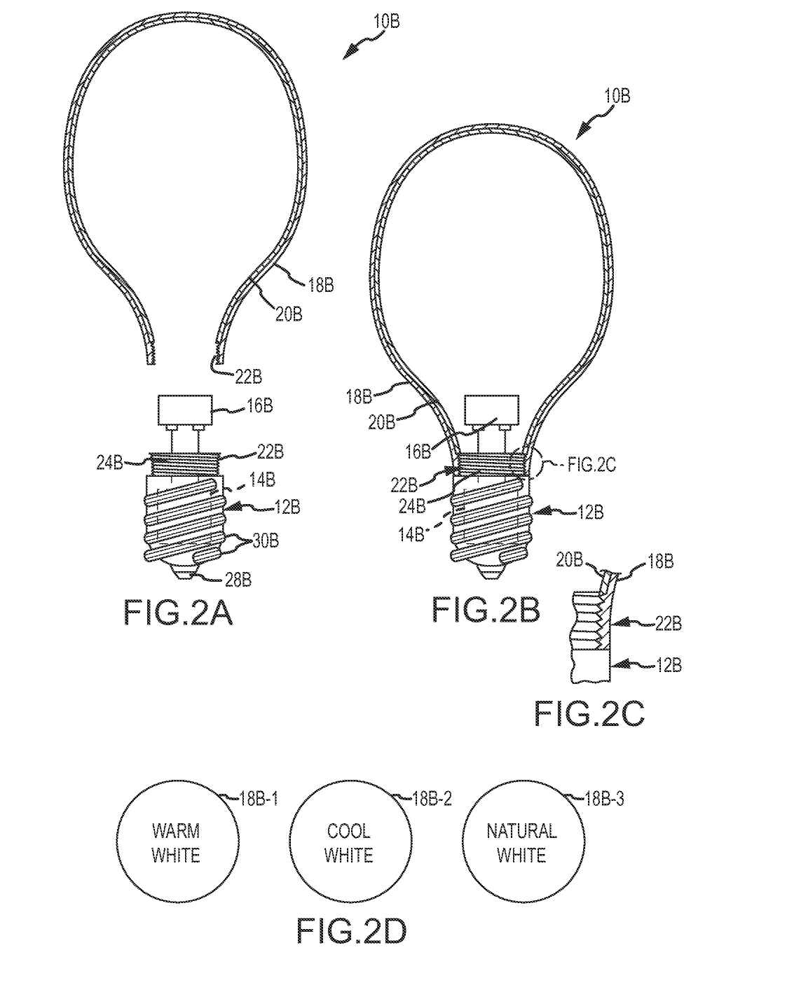

Referring to FIGS. 2A-2D, a second light emitting diode (LED) lighting system 10B is shown in an unassembled condition in FIG. 2A, and in an assembled condition in FIG. 2B. The light emitting diode (LED) lighting system 10B is in the form of an “A-type” form factor light bulb. In addition, rather than being a separate lens, the wavelength conversion lens 20B is formed directly on the cover 18B. Further, the light emitting diode (LED) lighting system 10B includes a plurality of interchangeable covers 18B-1, 18B-2 and 18B-3 (FIG. 2D), substantially as previously described for interchangeable lenses 20A-1, 20A-2 and 20A-3 (FIG. 1B).

The light emitting diode (LED) lighting system 10B includes a base 12B having a power supply 14B, an LED module 16B mounted to the base 12B in electrical communication with the power supply 14B configured to emit electromagnetic radiation having a selected wavelength range, a heat sink 24B on the base 12B, and a cover 18B configured for removable attachment to the base 12B containing a wavelength conversion lens 20B. The light emitting diode (LED) lighting system 10B also includes an attachment mechanism 22B in the form of male threads on the base 12B and mating female threads on the cover 18B, that allow the cover 18B to be attached to, and removed from the base 12B. Advantageously, by attaching different covers 18B-1, 18B-2 and 18B-3, different electromagnetic emission outputs from the light emitting diode (LED) lighting system 10A can be achieved.

The base 12B has a metal screw cap configuration with an electrical contact 28B at the tip and threaded contacts 30B, which also provide mechanical support in a mating socket. Alternately, the base 12B can have other contact arrangements such as bayonet, candelabra, mogul, or screw terminals for connection to wires. The base 12B also includes the power supply 14B for the LED module 16B, which can include an AC-DC converter, a driver circuit and any other electrical components necessary for operating the LED module 16B.

The cover 18B can comprise a transparent, or a semi-transparent material, such as a plastic (e.g., polycarbonate), or a glass, formed in a desired shape. For example, the cover 18B can have a bulbous shape as shown, or can have any other suitable shape (e.g., tubular, rectangular, dome, convex, concave). The female threads on the cover 18B for the attachment mechanism 22B can be formed using a suitable process such as molding or machining, and can have a desired size, shape and thread count corresponding to that of the male threads on the base 12B.

The wavelength conversion lens 20B can comprise a layer of material configured to convert at least some of the electromagnetic radiation produced by the LED module 16B into electromagnetic radiation having a different wavelength. For example, the wavelength conversion lens 20B can comprise a layer of phosphor which covers the inside surface of cover 18B. The electromagnetic radiation emitted by the LED module 16B combined with the electromagnetic radiation converted by wavelength conversion lens 20B produces the electromagnetic radiation produced by the light emitting diode (LED) lighting system 10B. In addition, different covers 18B-1, 18B-2 and 18B-3 can be attached (or removed) by a user of the light emitting diode (LED) lighting system 10B, such as a consumer, substantially as previously described to achieve a desired electromagnetic radiation output (e.g., perceived white light). The wavelength conversion lens 20B can be deposited on the cover 18B using a suitable process such as spraying, dipping, spin coating, rolling, electro deposition or vapor deposition to a desired thickness. Rather than being a deposited layer, the wavelength conversion lens 20B can also be incorporated into the material of the cover 18B using a suitable process, such as mixing with a molded plastic material or a rolled glass material.

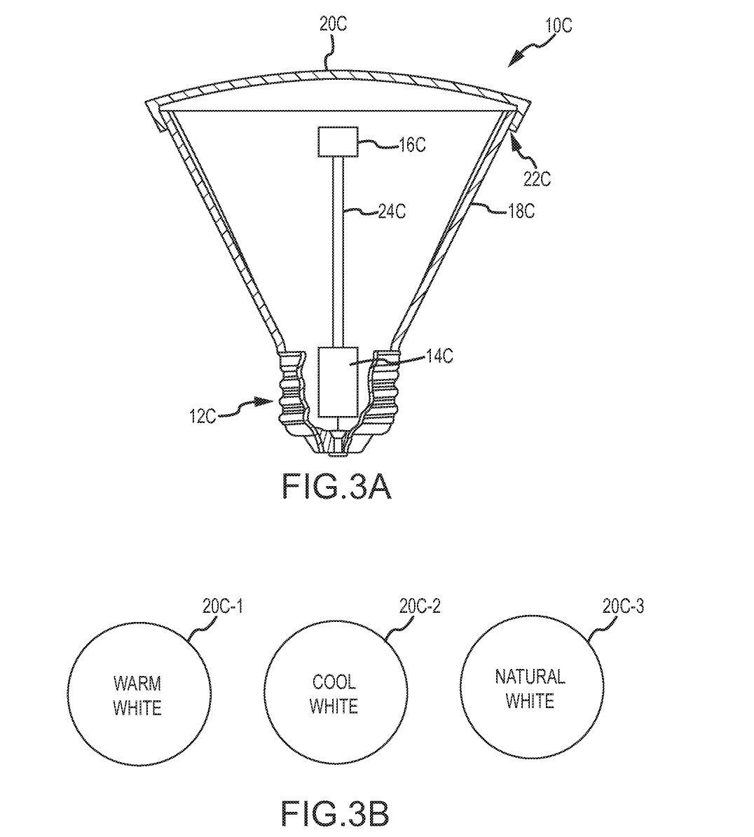

Referring to FIGS. 3A and 3B, a third light emitting diode (LED) lighting system 10C includes a base 12C having a power supply 14C, a heat sink 24C on the base 12B, and an LED module 16C mounted to the base 12C in electrical communication with the power supply 14C configured to emit electromagnetic radiation having a selected wavelength range. The light emitting diode (LED) lighting system 10C also includes a cover 18C and a wavelength conversion lens 20C configured for removable attachment to the base 12A. The wavelength conversion lens 20C is constructed substantially as previously described for wavelength conversion lenses 20A-1, 20A-2 and 20A-3 (FIG. 1B) but with a concave shape and a slip fit attachment. The light emitting diode (LED) lighting system 10C also includes a plurality of interchangeable wavelength conversion lenses 20C-1, 20C-2 and 20C-3 (FIG. 3B) for changing the electromagnetic radiation output of the LED module 16C to achieve a desired electromagnetic radiation output for the light emitting diode (LED) lighting system 10A. The light emitting diode (LED) lighting system 10C also includes an attachment mechanism 22C for removeably attaching the wavelength conversion lenses 20C-1, 20C-2, 20C-3 to the base 12C. For example, the attachment mechanism 22C can be in the form of a slip fit between the wavelength conversion lens 20C and the cover 18C.

Thus the disclosure describes an improved light emitting diode (LED) lighting system having adjustable electromagnetic radiation output characteristics. While a number of exemplary aspects and embodiments have been discussed above, those of skill in the art will recognize certain modifications, permutations, additions and subcombinations thereof. It is therefore intended that the following appended claims and claims hereafter introduced are interpreted to include all such modifications, permutations, additions and sub-combinations as are within their true spirit and scope.

What is claimed is:

1. A light emitting diode (LED) lighting system comprising:
a base;
a power supply on the base;
a LED module on the base in electrical communication with the power supply comprising at least one LED die configured to emit electromagnetic radiation having a selected wavelength range;
a first wavelength conversion lens configured for removable attachment to the base in light communication with the LED module configured to change the electromagnetic radiation emitted by the LED module into a first wavelength range to produce a first electromagnetic radiation output for the system; and
a second wavelength conversion lens interchangeable with the first wavelength conversion lens configured to change the electromagnetic radiation emitted by the LED module into a second wavelength range to produce a second electromagnetic radiation output for the system different than the first electromagnetic radiation output.

2. The light emitting diode (LED) lighting system of claim 1 wherein the selected wavelength range comprises a blue spectral range, the first wavelength range comprises a first yellow spectral range and the second wavelength range comprises a second yellow spectral range.

3. The light emitting diode (LED) lighting system of claim 1 wherein the first electromagnetic radiation output comprises white light having a first color temperature and the second electromagnetic radiation output comprises white light having a second color temperature.

4. The light emitting diode (LED) lighting system of claim 1 further comprising a cover and an attachment mechanism configured to attach the cover and the first wavelength conversion lens or the second wavelength conversion lens to the base.

5. The light emitting diode (LED) lighting system of claim 4 wherein the attachment mechanism comprises an element selected from the group consisting of threads, screws, snap fits, press fits, compression rings, snap taps and adhesives.

6. The light emitting diode (LED) lighting system of claim 1 wherein the first lens and the second lens each comprises a transparent cover.

7. A light emitting diode (LED) lighting system comprising:
a base having a heat sink and a power supply;
a LED module on the base in thermal communication with the heat sink and in electrical communication with the power supply comprising at least one LED die configured to emit electromagnetic radiation having a selected wavelength range; and
a plurality of wavelength conversion lenses, each wavelength conversion lens configured for separate attachment to the base in light communication with the LED module, each wavelength conversion lens configured to convert at least some of the electromagnetic radiation emitted by the LED module to produce a different electromagnetic radiation output for the system comprising white light having a particular perceived color temperature.

8. The light emitting diode (LED) lighting system of claim 7 further comprising a cover configured to attach each wavelength conversion lens separately to the base.

9. The light emitting diode (LED) lighting system of claim 8 further comprising an attachment mechanism for attaching the cover and the wavelength conversion lenses to the base.

10. The light emitting diode (LED) lighting system of claim 9 wherein the attachment mechanism comprises an element selected from the group consisting of threads, screws, snap fits, press fits, compression rings, snap taps and adhesives.

11. The light emitting diode (LED) lighting system of claim 8 wherein each wavelength conversion lens comprises a separate element configured to attach to the cover.

12. The light emitting diode (LED) lighting system of claim 7 wherein each wavelength conversion lens comprises a wave length conversion layer formed on a different cover attachable to the base.

13. The light emitting diode (LED) lighting system of claim 7 wherein the perceived color temperature is selected from the group consisting of warm white (2700-3000 K) and cool white (over 5000 K).

14. The light emitting diode (LED) lighting system of claim 7 wherein the base comprises an element selected from the group consisting of screw cap, bayonet, candelabra, mogul, or screw terminals for connection to wires.

15. A light emitting diode (LED) lighting system comprising:
a base having a heat sink and a power supply;
a LED die mounted to the base in thermal communication with the heat sink and in electrical communication with the power supply configured to emit electromagnetic radiation in a selected spectral range;
a first lens configured for removable attachment to the base having a first wavelength conversion material configured to convert at least some of the electromagnetic radiation emitted by the LED die to produce an electromagnetic radiation output for the system comprising white light having a first color temperature; and
a second lens interchangeable with the first lens having a second wavelength conversion material configured to convert at least some of electromagnetic radiation emitted by the LED die to produce an electromagnetic radiation output for the system comprising white light having a second color temperature.

16. The light emitting diode (LED) light bulb of claim 15 wherein the selected spectral range has a wavelength of from 450 to 490 nm.

17. The light emitting diode (LED) lighting system of claim 15 wherein the first lens and the second lens each comprises a transparent cover having an attachment mechanism selected from the group consisting of threads, screws, snap fits, press fits, compression rings, snap taps and adhesives.

18. The light emitting diode (LED) lighting system of claim 15 a cover configured to attach the first lens and the second lens to the base, the cover having a configuration selected from the group consisting of spotlight, form factor, vivid, miniature, subminiature, Dulux, u-shape, circline, octron, slimline, automotive and special purpose.

19. The light emitting diode (LED) lighting system of claim 15 wherein the first color temperature and the second color temperature are selected from the group consisting of warm white, cool white and natural white.

20. The light emitting diode (LED) light bulb of claim 15 wherein the base includes a contact on the tip and thread contacts configured for mating engagement with a socket.
